(19) United States
(12) Patent Application Publication
(10) Pub. No.: US 2023/0385962 A1
(43) Pub. Date: Nov. 30, 2023

(54) TERMINAL APPARATUS, PAYMENT METHOD, AND PROGRAM

(71) Applicant: NEC Corporation, Minato-ku, Tokyo (JP)

(72) Inventor: Toru Aoyagi, Tokyo (JP)

(73) Assignee: NEC Corporation, Minato-ku, Tokyo (JP)

(21) Appl. No.: 18/030,897

(22) PCT Filed: Oct. 7, 2021
(86) PCT No.: PCT/JP2021/037169

§ 371 Date: Apr. 7, 2023

(30) Foreign Application Priority Data
Oct. 20, 2020 (JP) 2020-175965

(51) Int. Cl. G06Q 50/12; G06Q 20/40

(52) U.S. Cl. CPC G06Q 50/12; G06Q 20/40145

(57) ABSTRACT

An order terminal (100) includes an authentication unit (102) that performs authentication related to a payment means by transmitting, before receiving order information from a customer, payment means determination information of the customer to a server that authenticates the payment means and causing the server to perform predetermined payment processing; a reception unit (104) that receives order information of the customer after the authentication is successful; and a payment unit (106) that causes the server to perform payment processing related to the order information by using the acquired payment means determination information.

### TECHNICAL FIELD

The present invention relates to a terminal apparatus, a payment method, and a program, and particularly relates to a terminal apparatus, a payment method, and a program that receive an order in a restaurant.

### BACKGROUND ART

In recent years, in a restaurant, a bar, and the like, work efficiency has been demanded in order to reduce a labor cost or solve labor shortage by reducing the number of employees and achieving labor saving. Patent Document 1 discloses allowing a customer to perform accounting processing by using a self-accounting machine in a restaurant.

Patent Document 2 discloses a facility in which settlement processing is further unmanned in a restaurant such as a conveyor belt sushi store where order reception and serving are unmanned. In the facility, identification information and a holding balance of electronic money are acquired by causing a card reader to read an electronic money medium such as a contactless IC card of a customer when the customer enters a store. This electronic money is allowed to be used for payment of a price. A devise to secure collection of payment has been performed by receiving an order of a customer by an ordering apparatus and restricting the order in such a way that a sum of an order amount does not exceed the balance of the electronic money, or allowing a customer who forgot to perform accounting, and left the store to perform settlement when the customer enters the store next time.

Patent Document 3 describes an ordering system in which an order can be placed by photographing and capturing an image of a cuisine displayed on a menu with use of a mobile terminal of a customer. In the system, a customer performs membership registration in advance, and is also allowed to register a credit card for use in payment of a price, and in a case where confirmation and display of a payment method is performed with respect to a mobile terminal at a time of accounting, and a message that credit card payment is performed is received from the customer, settlement is performed by using the credit card registered in advance.

Patent Document 4 describes an order terminal in which a camera that photographs a face photo of an orderer is mounted on a main body, and the face photo of the orderer regarding order data being photographed by the camera is transmitted to a master apparatus together with the order data. Since the order data and the face photo of the orderer are associated with each other, presenting a face image together with order data or a payment amount at a time of confirming an order slip or payment allows an employee to serve while confirming the face of the orderer at a time of serving an ordered dish, or to receive accounting while confirming the face of the orderer by a POS terminal.

### RELATED DOCUMENTS

### Patent Documents

[Patent Document 1] Japanese Patent Application Publication No. 2019-125294
[Patent Document 2] Japanese Patent Application Publication No. 2017-146706
[Patent Document 3] Japanese Patent Application Publication No. 2010-238118
[Patent Document 4] Japanese Patent Application Publication No. 2004-206375

### SUMMARY OF INVENTION

### Technical Problem

In order to promote labor saving in a store, it is necessary to reduce labor necessary for payment in the store. In contrast, even in a case where labor saving in payment is promoted, it is also necessary to securely perform payment.

The present invention has been made in view of the above-described circumstances, and an object of the present invention is to reduce labor necessary for payment in a store, and secure payment certainty.

### Solution to Problem

In each aspect of the present invention, the following each configuration is adopted in order to solve the above-described problem.

A first aspect is related to a terminal apparatus.

An apparatus terminal according to the first aspect includes:
an authentication unit that performs authentication related to a payment means by transmitting, before receiving order information from a customer, payment means determination information of the customer to a server that authenticates the payment means and causing the server to perform predetermined payment processing;
a reception unit that receives order information of the customer after the authentication is successful; and
a payment unit that causes the server to perform payment processing related to the order information by using the acquired payment means determination information.

A second aspect is related to a payment method to be performed by at least one computer.

The payment method according to the second aspect includes, by a terminal apparatus:
performing authentication related to a payment means by transmitting, before receiving order information from a customer, payment means determination information of the customer to a server that authenticates the payment means and causing the server to perform predetermined payment processing;
receiving order information of the customer after the authentication is successful; and causing the server to perform payment processing related to the order information by using the acquired payment means determination information.

Note that, another aspect of the present invention may be a program causing at least one computer to execute the above-described method of the second aspect, or may be a computer-readable recording medium recording a program as described above. The recording medium includes a non-transitory tangible medium.

The computer program includes a computer program code causing a computer to implement the payment method on a terminal apparatus, when being executed by the computer. Note that, a configuration in which any combination of the above constituent elements, and expression of the present invention are converted among a method, an apparatus, a system, a storage medium, a computer program, and the like is also effective as an aspect of the present invention.

Further, various constituent elements of the present invention are not necessarily required to be individually independent existences, and a plurality of constituent elements may be formed as one member, one constituent element may be formed by a plurality of members, a certain constituent element may be a part of another constituent element, a part of a certain constituent element and a part of another constituent element may overlap each other, and the like.

Further, a plurality of procedures are described in order in a method and a computer program according to the present invention, but the described order does not limit the order in which a plurality of procedures are performed. For this reason, when a method and a computer program according to the present invention are implemented, the order of the plurality of procedures can be changed within a range that does not impair the content.

Furthermore, a plurality of procedures of a method and a computer program according to the present invention are not limited to a configuration in which the procedures are performed at individually different timings. For this reason, another procedure may occur during execution of a certain procedure, a part or all of an execution timing of a certain procedure and an execution timing of another procedure may overlap each other, and the like.

### Advantageous Effects of Invention

According to the above-described each aspect, it is possible to reduce labor necessary for payment in a store, and secure payment certainty.

### BRIEF DESCRIPTION OF THE DRAWINGS

FIG. 1 It is a diagram conceptually illustrating a system configuration of an ordering system according to an example embodiment of the present invention.

FIG. 2 It is a block diagram illustrating a hardware configuration of a computer achieving an order terminal.

FIG. 3 It is a functional block diagram illustrating a logical configuration of the order terminal according to a present example embodiment.

FIG. 4 It is a flowchart illustrating an operation example of the order terminal according to the present example embodiment.

FIG. 5 It is a flowchart illustrating an example of a procedure of advance preparation in a user terminal of a customer using a present ordering system.

FIG. 6 It is a diagram illustrating registration processing of personal identification information of a procedure P5 in FIG. 5.

FIG. 7 It is a flowchart illustrating one example of payment authentication processing.

FIG. 8 It is a diagram illustrating a display example of a screen at a time of the payment authentication processing.

FIG. 9 It is a flowchart illustrating a part of an operation example of the order terminal.

FIG. 10 It is a diagram illustrating a data structure example of a storage apparatus of the order terminal.

FIG. 11 It is a flowchart illustrating an operation example of the order terminal.

FIG. 12 It is a flowchart illustrating a part of an operation example of the order terminal.

FIG. 13 It is a flowchart illustrating an operation example of the order terminal.

FIG. 14 It is a flowchart illustrating a detailed operation example of payment means registration processing in step S301 in FIG. 13.

FIG. 15 It is a flowchart illustrating a detailed operation example of payment processing in step S311 in FIG. 13.

FIG. 16 It is a flowchart illustrating a detailed operation example of order reception processing in step S305 in FIG. 13.

FIG. 17 It is a diagram illustrating a data structure example of the storage apparatus of the order terminal.

FIG. 18 It is a flowchart illustrating another detailed operation example of the payment processing in step S311 in FIG. 13.

FIG. 19 It is a flowchart illustrating still another detailed operation example of the payment processing in step S311 in FIG. 13.

### EXAMPLE EMBODIMENT

In the following, example embodiments according to the present invention are described with reference to the drawings. Note that, in all drawings, a similar constituent element is indicated by a similar reference sign, and description thereof is not included as necessary. In the following each drawing, a configuration of a portion that is not related to the essence of the present invention is not included, and is not illustrated.

In the example embodiments, “acquisition” includes at least one of acquisition of data or information stored in another apparatus or a storage medium by an own apparatus (active acquisition), and input of data or information to be output from another apparatus to an own apparatus (passive acquisition). Examples of the active acquisition include requesting or inquiring another apparatus and receiving a reply, accessing to another apparatus or a storage medium and reading, and the like. Further, examples of the passive acquisition include receiving information to be distributed (or transmitted, push-notified, or the like), and the like. Further, “acquisition” may be acquiring by selecting from received data or information, or receiving by selecting distributed data or information.

### First Example Embodiment

<System Overview>

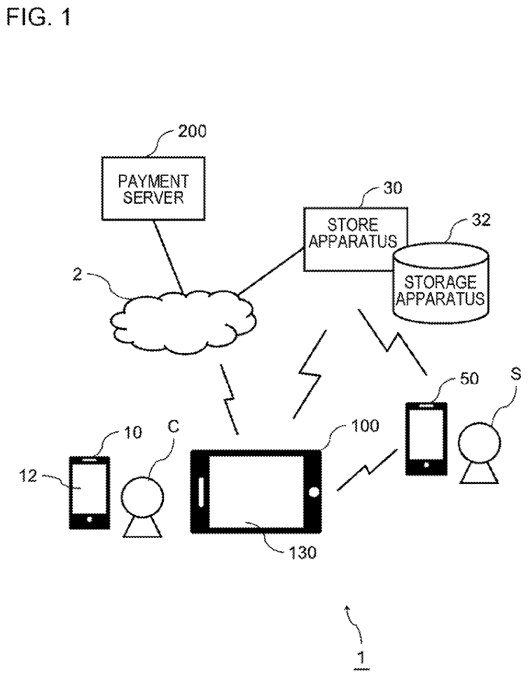

FIG. 1 is a diagram conceptually illustrating a system configuration of an ordering system 1 according to an example embodiment of the present invention. The ordering system 1 includes an order terminal 100, and a store apparatus 30.

The order terminal (terminal apparatus) 100 is a terminal that receives an order of a customer C in a store such as a restaurant or a bar, and is, for example, a dedicated terminal apparatus, a tablet terminal, or the like. At least one order terminal 100 is disposed, for example, for each table in a store. The order terminal 100 is a self-order terminal with which the customer C places an order by operating by himself/herself. The order terminal 100 includes an unillustrated storage apparatus 120.

The order terminal 100 is connectable to the store apparatus 30 and an employee terminal 50 via a communication network 2. Alternatively, the order terminal 100, the store apparatus 30, and the employee terminal 50 may be directly wirelessly communicable with one another. The order terminal 100 transmits received order information of the customer C to the store apparatus 30 via the communication network 2. The store apparatus 30 may have a function of receiving order information of the customer C, and conveying the order information to a kitchen, as an instruction to start cooking. The store apparatus 30 is a server apparatus that manages an order in a store. The store apparatus 30 includes a storage apparatus 32 that stores various pieces of data related to a store. The employee terminal 50 is a mobile terminal to be used by an employee S in a store, and may be, for example, a smartphone, a tablet terminal, a handy terminal for receiving an order, or the like.

A user terminal 10 is a mobile terminal owned or used by the customer C, and is, for example, a smartphone, a tablet terminal, or the like. The order terminal 100 is further connectable to a predetermined payment server 200, and is allowed to perform payment processing by being connected to the payment server 200 corresponding to a payment means being received by the order terminal 100 and to be used by the customer C.

In FIG. 1, only one payment server 200 is included, but the payment means usable by the customer C in a store may be plural. A store can improve convenience of the customer C by handling various payment means.

A payment means to be used by the customer C is a means that performs payment processing of a price to be paid to a store by the customer C by using a predetermined electronic payment service. A payment means using an electronic payment service or the like using a QR code (registered trademark) is one of the examples, but the present embodiment is not limited thereto. Any other payment means may be available, as far as a service is an electronic payment service using the user terminal 10, and, for example, a means that performs electronic payment processing by a credit card associated with the user terminal 10 may also be available.

<Hardware Configuration Example>

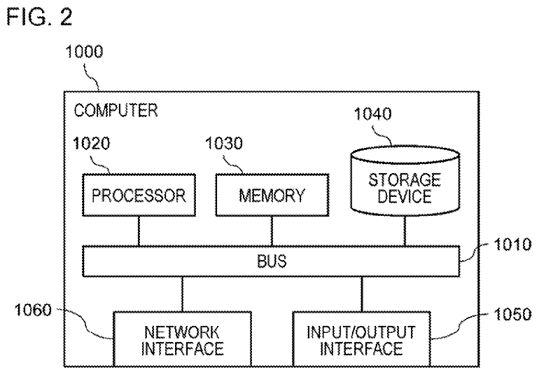

FIG. 2 is a block diagram illustrating a hardware configuration of a computer 1000 achieving the order terminal 100. Further, the user terminal 10, the store apparatus 30, the employee terminal 50, and the payment server 200 in FIG. 1 are also achieved by the computer 1000.

The computer 1000 includes a bus 1010, a processor 1020, a memory 1030, a storage device 1040, an input/output interface 1050, and a network interface 1060.

The bus 1010 is a data transmission path along which the processor 1020, the memory 1030, the storage device 1040, the input/output interface 1050, and the network interface 1060 mutually transmit and receive data. However, a method of mutually connecting the processor 1020 and the like is not limited to bus connection.

The processor 1020 is a processor to be achieved by a central processing unit (CPU), a graphics processing unit (GPU), or the like.

The memory 1030 is a main storage apparatus to be achieved by a random access memory (RAM) or the like.

The storage device 1040 is an auxiliary storage apparatus to be achieved by a hard disk drive (HDD), a solid state drive (SSD), a memory card, a read only memory (ROM), or the like. The storage device 1040 stores a program module achieving each function (e.g., an authentication unit 102, a reception unit 104, a payment unit 106, and the like to be described later) of the order terminal 100. The processor 1020 achieves each function corresponding to the program module by reading each program module in the memory 1030 and executing each program module. Further, the storage device 1040 may store each piece of data in the storage apparatus 120 of the order terminal 100.

The program module may be recorded in a storage medium. A recording medium storing the program module includes a non-transitory tangible medium usable by the computer 1000, and a program code readable by the computer 1000 (processor 1020) may be embedded in the medium.

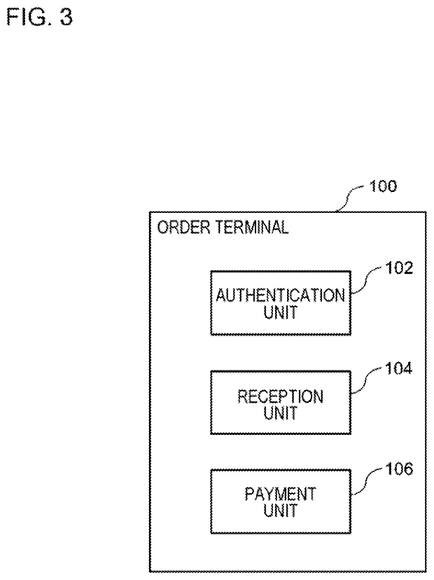

However, the order terminal 100 may have a configuration in which the order terminal 100 accesses to a server (e.g., a store server, a Web server, or the like), and a function of each constituent element in FIG. 3 to be achieved on the server is operated on the order terminal 100.

The input/output interface 1050 is an interface for connecting the computer 1000 and various pieces of input/output equipment with each other. The input/output interface 1050 also functions as a communication interface that performs short-range wireless communication such as Bluetooth (registered trademark) or near field communication (NFC).

The network interface 1060 is an interface for connecting the computer 1000 to the communication network 2 (FIG. 1). The communication network 2 is, for example, a local area network (LAN) or a wide area network (WAN). Alternatively, the network interface 1060 may be an interface to be connected to the communication network 2 by using a public line via a base station with use of various communication methods such as a 4th generation (4G), a 5th generation (5G), and worldwide interoperability for microwave access (WiMAX). A method of connecting the network interface 1060 to the communication network 2 may be wireless connection, or may be wired connection.

Further, the computer 1000 is connected to a necessary piece of equipment (e.g., a display 130 or a display 12 (touch panel) of the order terminal 100 or the user terminal 10, an operation button, a speaker, a microphone, a sensor that acquires biometric information of the customer C such as a camera and/or a fingerprint sensor, and the like) via the input/output interface 1050 or the network interface 1060.

As will be described later, the order terminal 100 or the user terminal 10 acquires personal identification information being a face image, or a feature value of a face extracted from the face image of the customer C for use in performing authentication processing of personal confirmation of the customer C. In the present example embodiment, authentication processing is performed by using, as personal identification information, a face image (feature value of a face) of a person, but authentication processing may be performed by using another piece of biometric authentication information. The biometric authentication information includes at least one of feature values such as an iris, a vein, an auricle, a fingerprint, and a voiceprint. Authentication processing may be performed by combining a plurality of pieces of biometric authentication information, as personal identification information.

Each of the order terminal 100 and the user terminal 10 may include an image recognition processing unit (not illustrated) for performing authentication processing using an image. The image recognition processing unit may be installed in the order terminal 100 and the user terminal 10, as one of program modules that achieves a function thereof. As another example, the image recognition processing unit may be achieved by a server apparatus (not illustrated) provided outside the order terminal 100 or the user terminal 10, and the order terminal 100 or the user terminal 10 may cause the server apparatus to perform image recognition processing by transmitting an image to the server apparatus via the communication network 2.

In the present example embodiment, since authentication processing using a face image is performed, a guidance screen for photographing a face of the customer C with use of a camera of the user terminal 10 or the order terminal 100 is displayed on a display of the user terminal 10 or the order terminal 100. In a case where authentication processing using another piece of biometric authentication information is performed, a sensor suitable for acquiring the another piece of biometric authentication information is used. For example, in a case where a fingerprint is used, fingerprint information is acquired by using a fingerprint sensor of the user terminal 10 or the order terminal 100. In a case where a voiceprint is used, a voice of the customer C is collected by using a microphone of the user terminal 10 or the order terminal 100, and voiceprint information is acquired.

The camera includes a lens, and an imaging element such as a charge coupled device (CCD) image sensor. An image to be generated by the camera is preferably a moving image, but also may be a frame image at a predetermined time interval, or may be a still image.

<Functional Configuration Example>

FIG. 3 is a functional block diagram illustrating a logical configuration of the order terminal 100 according to the present example embodiment. Each constituent element of the order terminal 100 according to the present example embodiment in FIG. 3 is achieved by any combination of hardware and software of the computer 1000 in FIG. 2. Further, a person skilled in the art may comprehend that there are various modification examples regarding a method and an apparatus for achieving each constituent element. A functional block diagram illustrating an information processing apparatus according to each example embodiment to be described in the following indicates a block of a logical functional unit, in place of a configuration of a hardware unit.

The order terminal 100 includes the authentication unit 102, the reception unit 104, and the payment unit 106.

Before receiving order information from the customer C, the authentication unit 102 performs authentication related to a payment means by transmitting payment means determination information of the customer C to the payment server 200 that authenticates the payment means and causing the payment server 200 to perform predetermined payment processing.

After the authentication is successful, the reception unit 104 receives order information of the customer C.

The payment unit 106 causes the payment server 200 to perform payment processing related to the order information by using the acquired payment means determination information.

The payment means determination information is, for example, identification information of QR code payment or a credit card, and the identification information indicates a payment means, and also includes identification information capable of determining the customer C being a user of the payment means. In other words, transmitting identification information of a payment means and a payment amount to the payment server 200 corresponding to the payment means together with a request to perform payment processing, based on the payment means determination information, allows the payment server 200 to perform payment processing of a price.

Personal identification information stored in a storage unit (the memory 1030 or the storage device 1040) of the user terminal 10 is, for example, face photo data or a feature value of a face of a person, of which personal confirmation has been performed by an electronic know your customer (eKYC) or the like in a registration procedure of personal identification information to be described later. As described above, the personal identification information may include another piece of biometric authentication information, for example, at least one of feature values such as an iris, a vein, an auricle, a fingerprint, and a voiceprint.

Order information of the customer C is, for example, information indicating order details of a meal, a beverage, or a service (such as a drink bar, a plate, and a wet towel) in a restaurant. The order terminal 100 causes the display 130 of the order terminal 100 to display an order screen on which an order of the customer C is received, and receives a product selected by the customer C and the number of the products specified by the customer C by operating a graphical user interface (GUI) such as an operation button, an icon, or a drumroll from a menu. A method of receiving an order is not limited thereto, and various methods can be employed.

<Operation Example>

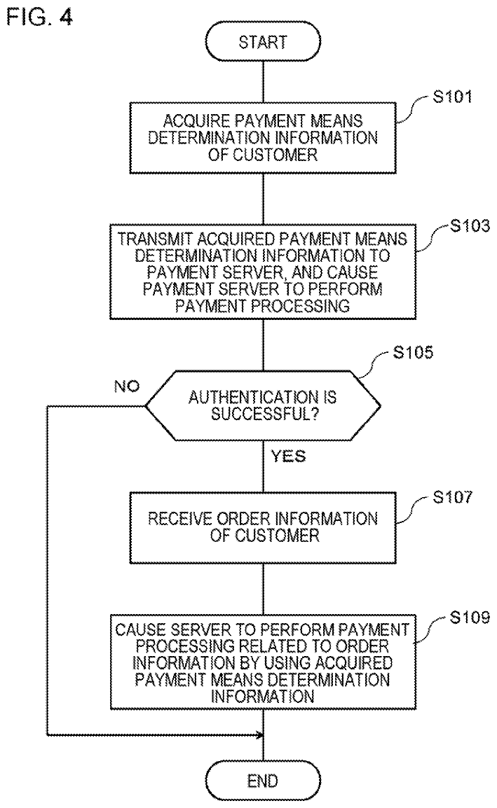

FIG. 4 is a flowchart illustrating an operation example of the order terminal 100 according to the present example embodiment.

First, the authentication unit 102 acquires payment means determination information of the customer C (step S101). For example, a QR code in which payment means determination information displayed on the user terminal 10 of the customer C is recorded is captured by using a camera of the order terminal 100, and the QR code is read from the captured image. At this occasion, a guidance screen for reading the QR code from the user terminal 10 is displayed on the display 130 of the order terminal 100. The customer C can perform a reading operation of the QR code according to a guidance.

Alternatively, the QR code may be read by using a QR code reader connected to the order terminal 100. The authentication unit 102 acquires detection means determination information from the read QR code. Alternatively, the authentication unit 102 may receive, by wireless communication such as near field communication (NFC), credit card information and the like recorded in a contactless IC card of the user terminal 10, as payment means determination information.

Then, the authentication unit 102 transmits the payment means determination information acquired in step S101 to the payment server 200, and causes the payment server 200 to perform predetermined payment processing (step S103). The payment server 200 is a server capable of performing payment processing by a payment means indicated by the payment means determination information of the customer C. In other words, the authentication unit 102 determines the payment server 200 capable of performing payment processing by the payment means indicated by the acquired payment means determination information, transmits identification information of the determined payment means of the customer C to the payment server 200, and requests predetermined payment processing.

The predetermined payment processing is, for example, payment processing (also referred to as empty payment processing, 0 yen payment processing, or the like) in which a payment amount is set to a predetermined amount (e.g., a minimum amount such as 0 yen or 1 yen). As another example, the predetermined payment processing may be payment processing (also referred to as provisional payment processing, reservation payment processing, or the like) in which at least a part of a flat rate such as a table charge, for which payment is necessary regardless of order details, is set as a payment amount.

Further, the authentication unit 102 receives a result of causing the payment server 200 to perform predetermined payment processing by using the payment means of the customer C. In a case where payment processing has been completed in a normal manner, an authentication result indicating that payment processing is successful is replied from the payment server 200 to the order terminal 100.

In the present example embodiment, the authentication unit 102 transmits that a payment amount is 0 yen together with a payment request information of requesting payment to the payment server 200 in predetermine payment processing. Further, a condition that authentication is successful is that the payment is completed.

In a case where predetermined payment processing has not been completed in a normal manner, an authentication result indicating that payment authentication has failed is replied from the payment server 200 to the order terminal 100. In a case where payment processing has not been completed in a normal manner, the payment means attempted to be used by the customer C cannot be used. Thus, since the order terminal 100 cannot use the payment means, the customer C may be notified that it is necessary to perform authentication processing by using another payment means.

For example, a message notifying the customer C to perform authentication processing again by using another payment means, because the payment means cannot be used, may be displayed on the display 130 of the order terminal 100, or audio processing may be performed from a speaker of the order terminal 100. Further, a failure of payment authentication of the customer C may be notified from the order terminal 100 to at least one of the store apparatus 30 and the employee terminal 50. The store apparatus 30 may record, in the storage apparatus 32, information notified from the order terminal 100. For example, identification information of the order terminal 100, a face photo or information on a feature value of a face of the customer C captured by a camera of the order terminal 100, a date and time, information on a payment means used for authentication, and an authentication result may be stored in association with one another.

In a case where an authentication result received from the payment server 200 indicates that authentication is successful (YES in step S105), the authentication unit 102 stores the payment means determination information in the storage apparatus 120, the processing proceeds to step S107, and also order reception processing by the reception unit 104 is started. However, whereas, in the present example embodiment, payment means determination information is stored in the storage apparatus 120 in a case where authentication is successful in step S105, in a second example embodiment to be described later, since payment means determination information of the customer C is acquired again at a time of payment processing at an accounting time, the payment means determination information does not have to be stored in the storage apparatus 120.

In the present example embodiment, since the payment means determination information of the customer C acquired in step S101 is used not only for payment processing in step S103 but also at an accounting time, a message to the customer C, of which the payment means determination information has been acquired in step S101, indicating that the information is also used at an accounting time, is displayed on the display 130 of the order terminal 100. Further, by receiving pressing of an approval button on the screen, the payment means determination information can be used in payment processing in step S109. In a case where pressing of the approval button is not received, a guidance screen is displayed on the order terminal 100, and a QR code 310 is displayed again on the user terminal 10 similarly to a configuration of the second example embodiment to be described later. Further, a method of a reading operation of a QR code displayed on the user terminal 10 by using a camera of the order terminal 100 is provided on the guidance screen.

On the other hand, in a case where an authentication result received from the payment server 200 indicates that authentication has failed (NO in step S105), the authentication unit 102 finishes the present processing. At this occasion, it is preferable that the order terminal 100 performs the above-described notification processing.

In step S107, the reception unit 104 receives an order operation by the customer C. The customer C can place an order by operating on a screen displayed on the display 130 of the order terminal 100. Further, when the customer C finishes eating and drinking, and leaves the store, accounting is performed. At this occasion, the payment unit 106 performs payment processing of a payment amount of the customer C by using the payment means determination information. The payment means determination information is acquired in step S101 and indicates a payment means, of which payment authentication in step S103 has been completed in a normal manner (step S109). At this occasion, as described above, in a case where payment processing such as 1 yen or at least a part of a table charge has been performed in step S103, payment processing is performed by an amount acquired by subtracting the already paid amount in step S103.

An accounting timing is exemplified in the following, but is not limited thereto. The following plurality of pieces of timing may be combined.

(1) At a time when pressing of an accounting button or the like for performing accounting processing is received on an operation screen of the order terminal 100

(2) At a time when pressing of an accounting button or the like for performing accounting processing is received by the user terminal 10 of the customer C, on a website in which the customer C logs in to the ordering system 1, or by an application

In a case of (2), receiving pressing of the accounting button by the user terminal 10 may be notified to the order terminal 100 via a server of the ordering system 1. Alternatively, receiving may be directly notified from the user terminal 10 to the order terminal 100 by wireless communication.

(3) After pressing of the accounting button has been received in (1) or (2), biometric information (e.g., a feature value of a face) of the customer C is acquired, the biometric information and personal identification information stored in the storage apparatus 120 are collated with each other, and at a time when authentication is successful (payment processing is performed by a payment means indicated by payment means determination information being associated with personal identification information, of which authentication is successful)

(4) An operation of the customer C is not necessary, and after the customer C finishes eating and drinking, and leaves the store, payment processing is automatically performed. However, in this case, when predetermined payment processing by the authentication unit 102 is performed when the customer C enters the store, pressing of the approval button to be displayed on a screen to be displayed on the user terminal 10 or the order terminal 100 is received in order to acquire approval of the customer C in advance.

Further, various methods of detecting that the customer C leaves a store are conceived. For example, a connection state between the user terminal 10 of the customer C, and the order terminal 100 or predetermined communication equipment (such as an access point of wireless fidelity (Wi-Fi)) is surveyed, and in a case where a disconnected state of connection is continued for a predetermined time or longer, it may be determined that the customer C has left the store. Alternatively, tracking processing of the customer C may be performed by a surveillance camera or the like installed in a store, and leaving the store may be detected.

<Advance Preparation>

The customer C performs user registration in advance to use a service of the present ordering system 1. Hereinafter, a specific example is described.

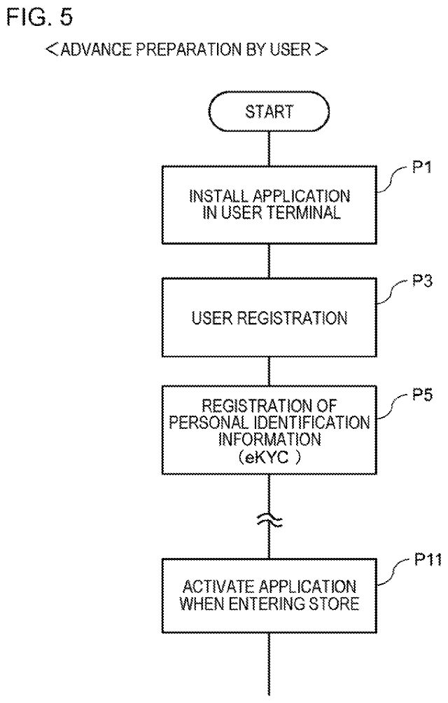

FIG. 5 is a flowchart illustrating an example of a procedure of advance preparation in the user terminal 10 of the customer C using the present ordering system 1. First, an application for using the present ordering system 1 is installed in the user terminal 10 (procedure P1). Alternatively, the ordering system 1 may be used by accessing to a predetermined website via a browser.

Then, a user registration procedure is performed in order to use the ordering system 1 (procedure P3). In the user registration procedure, account information (e.g., a user name and a password) for login to the ordering system 1 is registered. Alternatively, account information of a predetermined SNS may be registered.

Next, registration processing of personal identification information for use in personal confirmation is performed (procedure P5). Details on the registration processing are described later. When registration processing of personal identification information is completed, advance preparation is finished. After this, the present ordering system 1 can be used by activating an application (procedure P11) or logging in to a predetermined website.

<P5: Registration of Personal Identification Information (eKYC)>

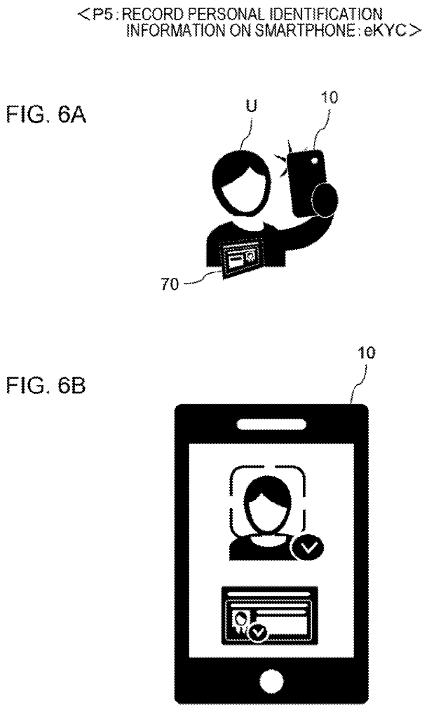

Hereinafter, registration processing of personal identification information in the procedure P5 in FIG. 5 is described by using FIG. 6. However, in the registration processing, a procedure of personal confirmation (eKYC) provided by a business person of a payment means (e.g., an electronic payment service) to be used in a store may be used.

FIG. 6 is a diagram illustrating registration processing of personal identification information in the procedure P5 in FIG. 5. As illustrated in FIG. 6(a), the customer C photographs a face photo printed on a card surface of an identification card 70 attached with a face photo, for example, a driver's license or a national identification number card, together with his/her face by using a camera of the user terminal 10. FIG. 6(b) illustrates a scene in which an image acquired by photographing a face of the person himself/herself, and an image acquired by photographing the identification card 70 including the face photo on a card surface of the identification card 70 are captured in the user terminal 10. The registration processing of personal identification information may be performed by installing an application for personal confirmation (eKYC) in the user terminal 10, or may be performed on a predetermined website via a browser.

It is preferable to perform photographing by a moving image, and perform liveness verification in order to guarantee that the person exists, in place of that a photographed face is “impersonation” or the like using a photo or the like.

Further, a face feature value extracted from each of the face image of the customer C himself/herself and the face photo of the identification card 70 is collated. As a result of the collation. in a case where it is authenticated that the customer C is the person, the authenticated face feature value is stored in a storage unit of the user terminal 10, as personal identification information.

<P11: Processing when Entering Store>

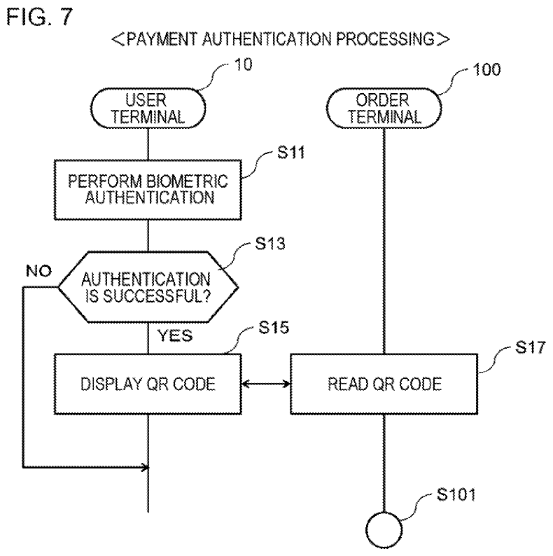

FIG. 7 is a flowchart illustrating one example of payment authentication processing.

First, the customer C activates an application of the ordering system 1 in the user terminal 10. In the ordering system 1, when entering a store, processing (also referred to as payment authentication processing) of authenticating a payment means that the customer C is planning to use is performed in order to perform registration of a person who performs accounting, in other words, registration of an electronic payment means for use in performing payment of a price pertaining to use in the store. First, a guidance screen 300 for performing payment authentication is displayed on the display 12 of the user terminal 10. However, personal confirmation processing in FIG. 7 may be performed by a system of each payment means. In other words, in a system of a payment means that the customer C is planning to use, the processing may be personal confirmation processing to be performed by using the user terminal 10 before use of the payment means.

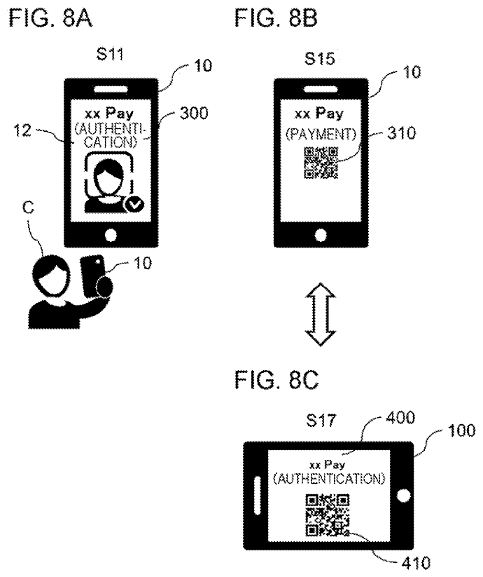

A guidance for performing personal confirmation necessary before electronic payment is performed is output on the screen 300. The customer C photographs his/her face by using a camera of the user terminal 10 according to the guidance, and causes the user terminal 10 to perform authentication processing (step S11) (FIG. 8(a)).

At this occasion, personal identification information registered in advance in the user terminal 10 and a feature value of a face captured by a camera are collated with each other in the user terminal 10. At a time of photographing a face of the customer C, it is preferable to perform photographing by a moving image, and perform liveness verification in order to guarantee that the person exists, in place of that a photographed face is “impersonation” or the like using a photo or the like. As a result of collation between the face of the captured image and the personal identification information, when it is authenticated that the customer C is the person (YES in step S13 in FIG. 7), as illustrated in FIG. 8(b), the QR code 310 for payment is displayed on the user terminal 10 (step S15).

On the other hand, a guidance screen 400 for reading the QR code 310 from the user terminal 10 by the authentication unit 102 is displayed on the order terminal 100. The customer C photographs the QR code 310 displayed on the user terminal 10 according to a guidance with use of a camera of the order terminal 100, and causes the order terminal 100 to read the QR code 310 (step S17). FIG. 8(c) illustrates an example in which a QR code 410 is displayed on the screen 400 in which the QR code 310 displayed on the user terminal 10 of the customer C is photographed by the order terminal 100.

Further, in the order terminal 100, the processing proceeds to step S101 in FIG. 4 described above, and the authentication unit 102 acquires payment means determination information acquired from the QR code 310. Further, it transmits, to the payment server 200 corresponding to a payment means, payment information (a payment amount of 0 yen, and identification information of the payment means of the customer C) in order to perform predetermined payment processing (e.g., 0 yen payment) by using the payment means (in the drawings, “xx Pay”) indicated by the payment means determination information.

In the payment server 200, 0 yen payment processing is performed, and when the payment processing is successful, an authentication result indicating that the payment means has been authenticated is replied to the order terminal 100. In the order terminal 100, when the authentication result indicating that payment processing is successful is received, the processing proceeds to an order screen, and the customer C is allowed to input an order.

As described above, in the present example embodiment, before receiving order information from the customer C, the authentication unit 102 performs authentication related to a payment means by transmitting payment means determination information of the customer C to a server that authenticates the payment means and causing the payment server 200 to perform predetermined payment processing (e.g., 0 yen payment processing). After the authentication is successful, the reception unit 104 receives order information of the customer C. The payment unit 106 causes the payment server 200 to perform payment processing related to the order information by using the acquired payment means determination information.

According to the configuration, since the customer C can perform payment processing by himself/herself, it is possible to reduce labor necessary for payment in a store. Further, since it is possible to confirm that payment processing can be performed by a payment means of the customer C before an order is placed, and also perform payment processing of order information by using payment means determination information acquired at that time, it is possible to secure payment certainty.

In a case where transaction by cash is performed, the employee S needs to serve a customer, however, according to the present example embodiment, since cashless payment is performed, the employee S does not have to serve a customer. According to the present example embodiment, since order reception and payment processing in a restaurant can be performed only by allowing the customer C to operate the order terminal 100 by himself/herself, the present example embodiment can contribute to labor saving, and reduce a labor cost or solve labor shortage. Further, since, in cashless payment, a person does not have to touch a coin and a banknote, there is also a possibility that an infection risk by an infectious disease can be reduced.

### Second Example Embodiment

The first example embodiment described above is configured in such a way that re-provision and re-reading of a QR code are not performed in payment processing at an accounting time. A present example embodiment includes a configuration in which re-provision and re-reading of a QR code are performed in payment processing at an accounting time. Since a configuration of an order terminal 100 is similar to that in the first example embodiment, description is made by using FIG. 3. A configuration of the present example embodiment can be combined with at least one of other example embodiments to be described later within a consistent range.

A payment unit 106 according to the present example embodiment acquires again payment means determination information from a user terminal 10 of a customer C, when payment related to order information is performed.

<Operation Example>

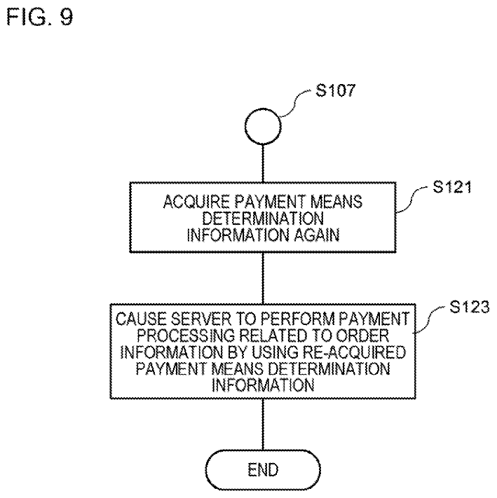

FIG. 9 is a flowchart illustrating a part of an operation example of the order terminal 100 according to the present example embodiment.

It is performed after step S107 in the flowchart in FIG. 4 indicating an operation according to the first example embodiment is performed. In other words, payment processing in steps S121 and S123 is performed when the customer C finishes order processing (step S107) and performs accounting when leaving a store. A timing when the payment processing is performed may be similar to at least one of (1) and (2) by an operation of the customer C among the timings described in the first example embodiment.

The customer C performs payment authentication processing similarly to the flow in FIG. 7 by the user terminal 10 before performing accounting. A screen 300 for performing payment processing by using a same payment means (however, another payment means may be available) as that used in payment authentication processing when entering a store is displayed on a display 12 of the user terminal 10.

Then, a face of the customer C is photographed according to a guidance on the screen 300, the photographed face of the customer C is collated with personal identification information stored in the user terminal 10, and authentication processing is performed (step S11 in FIG. 7). When authentication is successful (YES in step S13 in FIG. 7), a QR code 310 for use in accounting processing with use of the payment means is displayed on the screen 300 (step S15 in FIG. 7).

Then, the customer C photographs the QR code 310 displayed on the user terminal 10 with use of a camera of the order terminal 100 according to a guidance on a screen 400 for payment processing of the order terminal 100. An authentication unit 102 of the order terminal 100 photographs the QR code 310 displayed on the user terminal 10, and acquires payment means determination information for accounting processing (step S121). Then, the payment unit 106 causes a payment server 200 to perform payment processing related to order information (information indicating order details received by the order terminal 100) of the customer C by using the payment means determination information acquired in step S121 (step S123).

Specifically, identification information of the payment means of the customer C, a payment amount, and a payment request are transmitted to the payment server 200 corresponding to the payment means indicated by the payment means determination information. The payment server 200 performs payment processing of the payment amount, based on the identification information of the payment means of the customer C according to the payment request. A payment processing result may be transmitted to the order terminal 100, and also transmitted to a destination (e.g., a mail address of the user terminal 10 or the like) registered in advance by the customer C.

According to the present example embodiment, when payment processing related to order information is performed, the payment unit 106 reads the QR code 310 for payment again from the user terminal 10 of the customer C, and acquires payment means determination information. Therefore, at an accounting time, a payment means for use in payment can be used after acquiring approval from the customer C. For example, since the customer C is also allowed to perform accounting by a payment means different from a payment means used in payment authentication when entering a store, it is convenient for the customer C. Further, since approval of the customer C is acquired for each payment processing, unauthorized use by another person can be effectively prevented.

### Third Example Embodiment

An order terminal 100 according to a present example embodiment is different from that in the above-described example embodiments in a point that the order terminal 100 includes a configuration in which personal identification information of a customer C is acquired from a user terminal 10 together with payment means determination information. Since the order terminal 100 according to the present example embodiment includes a same configuration as that of the order terminal 100 in FIG. 3, description is made by using FIG. 3.

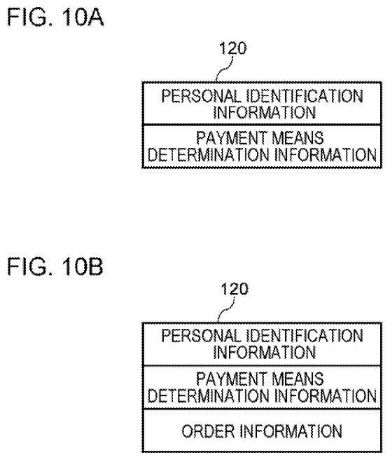

An authentication unit 102 acquires personal identification information of the customer C together with payment means determination information, and stores, in a storage apparatus 120 (FIG. 10(a)), the personal identification information and the payment means determination information in association with each other.

A reception unit 104 acquires biometric information of the customer C, when receiving order information of the customer C, collates the acquired biometric information with the personal identification information stored in the storage apparatus 120, and stores, in the storage apparatus 120 (FIG. 10(b)), the received order information in association with the personal identification information that matches the biometric information.

When performing payment processing related to order information, a payment unit 106 causes a payment server 200 to perform payment processing related to the order information being associated with the personal identification information of the customer C by using the payment means determination information being associated with the acquired personal identification information.

<Operation Example>

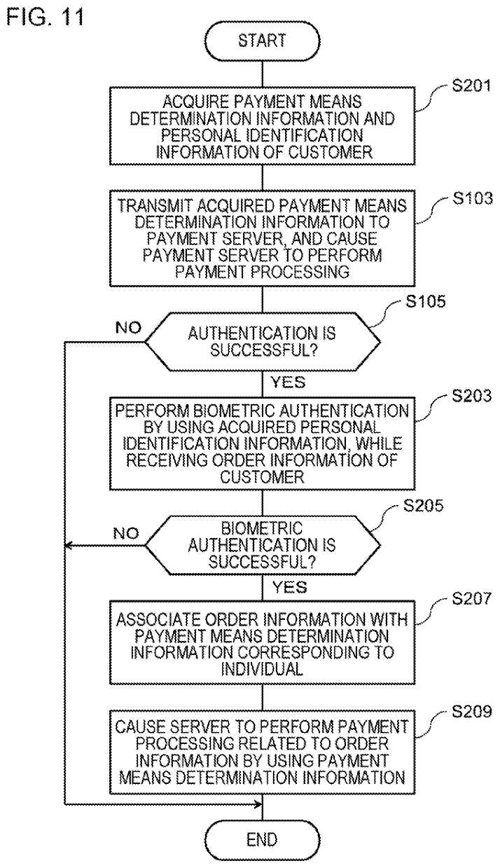

FIG. 11 is a flowchart illustrating an operation example of the order terminal 100 according to the present example embodiment. The flow in FIG. 11 includes steps S103 and S105 being the same as those in the flow in FIG. 4 of the order terminal 100 according to the first example embodiment, and further includes steps S201 to S209. Simple description is made regarding the same steps as those in FIG. 4.

First, the authentication unit 102 acquires payment means determination information and personal identification information of the customer C (step S201). In the present example embodiment, the QR code 310 to be displayed on the user terminal 10 of the customer C records thereon the personal identification information of the customer C together with payment means determination information. In other words, in step S15 in FIG. 7, the QR code 310 in which personal identification information is recorded together with payment means determination information of the customer C is displayed on a display 12 of the user terminal 10. The personal identification information is, for example, a feature value of a face of the customer C. The authentication unit 102 stores, in the storage apparatus 120 (FIG. 10(a)), the acquired personal identification information and the payment means determination information in association with each other.

Then, the authentication unit 102 transmits the payment means determination information acquired in step S101 to the corresponding payment server 200, and causes the payment server 200 to perform predetermined payment processing (step S103). When authentication is successful (YES in step S105), order reception processing by the reception unit 104 is started. When authentication has failed (NO in step S105), the present processing is finished. At this occasion, the order terminal 100 may cause a display 130 to display a message notifying the customer C of that authentication of the payment means has failed and registration could not be performed, or a message that a QR code 310 of another payment means is provided again in order to register the another payment means.

In the order reception processing, the customer C can place an order by operating on a screen displayed on the display 130 of the order terminal 100. The authentication unit 102 of the order terminal 100 photographs a face of the customer C who is performing an order operation with use of a camera of the order terminal 100, and acquires a feature value of the face of the customer C from a captured image. Then, the authentication unit 102 collates the acquired feature value of the face of the customer C with the personal identification information (feature value of a face) stored in the storage apparatus 120 (FIG. 10(a)).

As a result of the collation, in a case where the feature value of the face of the captured image of the customer C, and the personal identification information stored in the storage apparatus 120 have a degree of matching being equal to or more than a threshold value, authentication is successful (YES in step S205). In a case where personal identification information having a degree of matching being equal to or more than the threshold value is not stored in the storage apparatus 120, authentication has failed (NO in step S205). In a case where authentication has failed (NO in step S205), the present processing is finished. The authentication unit 102 may output a message (such as display on the display 130, or audio output from a speaker) of notifying the customer C of that an order cannot be received, because biometric authentication has failed. Further, information indicating that authentication of the customer C has failed may also be transmitted to a store apparatus 30 or an employee terminal 50.

In a case where authentication is successful (YES in step S205), the reception unit 104 stores, in the storage apparatus 120 (FIG. 10(b)), order information received by an operation of the customer C in association with the payment means determination information being associated with the personal identification information, of which authentication is successful in step S205 (step S207).

Then, when the customer C finishes eating and drinking, and leaves the store, accounting is performed. At this occasion, the payment unit 106 causes the payment server 200 to perform payment processing related to the order information of the customer C by using the payment means indicated by the payment means determination information being associated with the order information of the customer C in step S207 (step S209). At this occasion, as described above, in a case where payment processing such as 1 yen or at least a part of a table charge has been performed in step S103, payment processing is performed by an amount acquired by subtracting the already paid amount in step S103.

A timing when accounting is performed in the present example embodiment can be any of the timings (1) to (4) described in the first example embodiment.

According to the present example embodiment, the authentication unit 102 acquires personal identification information of the customer C together with payment means determination information by way of the QR code 310, further acquires a feature value of a face of the customer C during an order operation, collates the acquired feature value with the personal identification information, and an order is receives in a case where authentication is successful, or an order cannot be placed in a case where authentication has failed. This enables to prevent an impersonation behavior by another person.

### Modification Aspect of Third Example Embodiment

A modification aspect of the third example embodiment is different from the third example embodiment in a point that the modification aspect includes a configuration in which, when biometric authentication has failed, payment means determination information is acquired by performing re-reading a QR code and accounting processing is performed, and other features are similar to those in the third example embodiment.

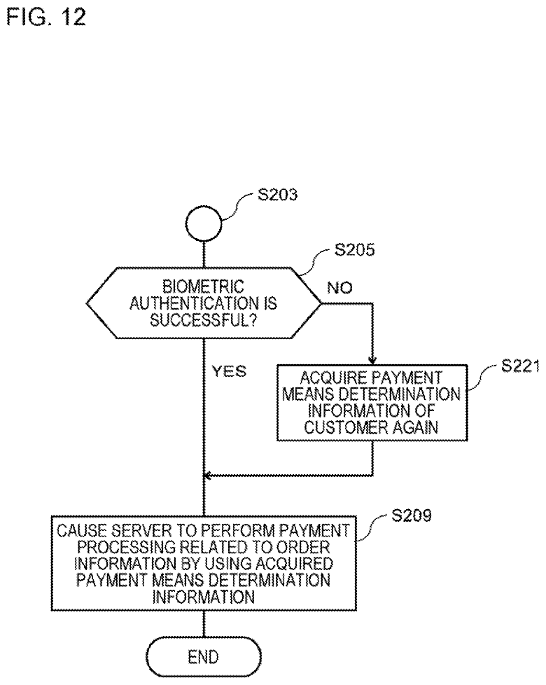

FIG. 12 is a flowchart illustrating a part of an operation example of an order terminal 100 according to the modification aspect of the third example embodiment. A flow in FIG. 12 further includes step S221, after biometric authentication processing of a customer C is performed in step S203 in FIG. 11.

In a case where biometric authentication of the customer C in step S203 has failed (NO in step S205), an authentication unit 102 acquires again payment means determination information of the customer C (step S221). Specifically, a guidance screen (not illustrated) is displayed on a display 130 of the order terminal 100, and the customer C is instructed in such a way as to cause a user terminal 10 to display and read a QR code 310 of a payment means being desired to be used by the customer C. The customer C performs personal confirmation processing (step S11) in FIG. 7 on the user terminal 10, and then, causes the user terminal 10 to display the QR code 310 (step S15).

A payment unit 106 of the order terminal 100 captures the QR code 310 displayed on a display 12 of the user terminal 10 with use of a camera, and acquires payment means determination information from the QR code 310. Then, the payment unit 106 causes a payment server 200 to perform payment processing related to order information by using the payment means determination information acquired in step S221 (step S209).

According to this configuration, in a case where biometric authentication of the customer C during reception of an order of the customer C by a reception unit 104 has failed, and payment means determination information of the customer C could not be determined, payment means determination information can be acquired by allowing the customer C to provide and read again the QR code 310 in which the payment means determination information is recorded. Then, the payment unit 106 can perform payment processing related to order information by using the acquired payment means determination information.

### Fourth Example Embodiment

A present example embodiment is similar to the third example embodiment in a configuration except for a point that the present example embodiment includes a configuration in which a plurality of customers C can place an order by using a same order terminal 100, and perform accounting by splitting a bill. Since a configuration of the order terminal 100 is the same as that of the first example embodiment, description is made by using FIG. 3.

In the present example embodiment, an authentication unit 102 acquires payment means determination information and personal identification information for each customer C, regarding each of a plurality of the customers C. Specifically, the authentication unit 102 reads a QR code 310 displayed on a display 130 of the order terminal 100 of each customer C, and acquires payment means determination information and personal identification information from the QR code 310.

However, regarding a customer C who does not perform payment of a price, reading of the QR code 310 is not required. The acquired payment means determination information and personal identification information are stored in a storage apparatus 120 (FIG. 10(a)) by the number of customers C, from which information has been acquired.

A reception unit 104 photographs a face of the customer C who is placing an order by the order terminal 100 with use of a camera, and collates a feature value of the face of the captured image with the personal identification information (feature value of a face) of the customer C stored in the storage apparatus 120. Further, the reception unit 104 determines payment means determination information being associated with the personal identification information having a degree of matching with the captured image being equal to or more than a threshold value, and stores, in the storage apparatus 120 (FIG. 10(b)), order information of the customer C in association with the determined payment means determination information.

At an accounting time, a payment unit 106 causes a payment server 200 to perform payment processing related to order information of the customer C being associated with payment means determination information by using a payment means indicated by the payment means determination information of the customer C, for each customer C.

<Operation Example>

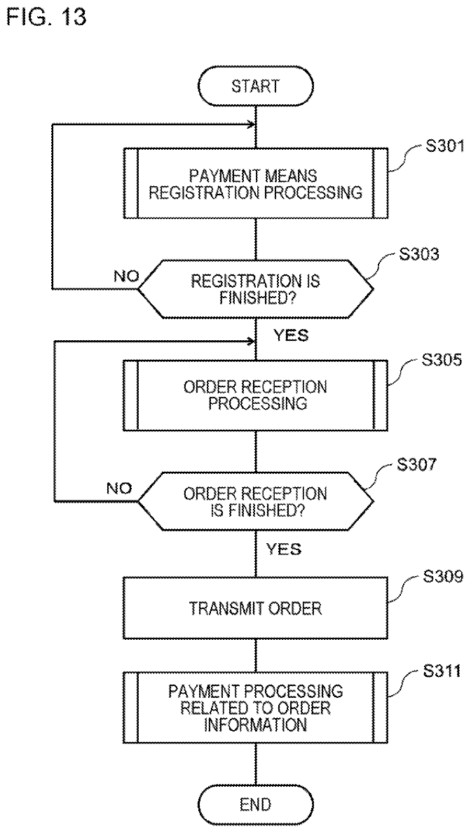

FIG. 13 is a flowchart illustrating an operation example of the order terminal 100 according to the present example embodiment.

Also in the present example embodiment, personal identification information of the customer C is recorded in the QR code 310 to be displayed on a user terminal 10 of each customer C together with payment means determination information. As described in step S15 in FIG. 7, each customer C causes the user terminal 10 to display the QR code 310. Personal identification information is recorded in the QR code 310 together with payment means determination information of the customer C. The personal identification information is, for example a feature value of a face of the customer C.

First, in step S301, each customer C performs registration processing of a payment means for use in accounting. Details on the registration processing are described later. Payment means registration processing in step S301 is repeated for each customer C during a time (NO in step S303) until pressing of a registration completion button of finishing registration processing of a payment means is received on a screen 400. Then, when registration processing of a payment means for all the customers C, or at least one customer C who performs accounting is finished, the authentication unit 102 finishes the payment means registration processing by receiving pressing of the registration completion button on the screen 400 (YES in step S303).

Then, the reception unit 104 starts order reception processing (step S305). At this occasion, an order reception screen is displayed on the order terminal 100. Details on the order reception processing are described later. The order reception processing in step S305 is continued during a time (NO in step S307) until receiving an order by the number of the customers C is finished, and pressing of an order determination button on an order screen is received. Then, when an order of the customers C is finished, the reception unit 104 finishes the order reception processing by receiving pressing of the order determination button on the order screen (YES in step S307). Then, the reception unit 104 transmits order information to a store apparatus 30, as order information (step S309). In the store apparatus 30, upon receiving the order information, the order information is conveyed to a kitchen, and cooking is started.

Then, when the customers C finish eating, and leave the store, the payment unit 106 performs payment processing related to the order information received in step S305 (step S311). Details on the payment processing are described later.

<S301: Payment Means Registration Processing>

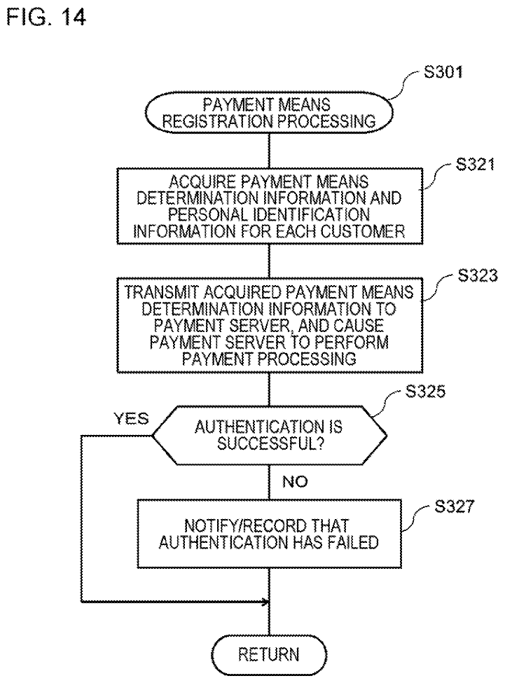

FIG. 14 is a flowchart illustrating a detailed operation example of the payment means registration processing in step S301 in FIG. 13.

First, the authentication unit 102 acquires payment means determination information and personal identification information of the customer C by photographing the QR code 310 displayed on the user terminal 10 of the customer C with use of a camera of the order terminal 100 for each customer C (step S321). The authentication unit 102 stores, in the storage apparatus 120 (FIG. 10(a)), the personal identification information and the payment means determination information acquired from the QR code 310 displayed on the user terminal 10 of each customer C in association with each other.

Next, the authentication unit 102 transmits, to the payment server 200 associated with a payment means indicated by the payment means determination information, the payment means determination information of the customer C acquired in step S321, and causes the payment server 200 to perform predetermined payment processing (e.g., 0 yen payment processing) (step S323). When payment authentication of the customer C is successful (YES in step S325), order reception of the customer C by the reception unit 104 is enabled, and the processing waits for start of order reception processing, and returns to FIG. 13.

In step S303 in FIG. 13, until pressing of the registration completion button is received, steps S321 to S325 in FIG. 14 are repeated for the other customers C by the number of the customers C. Thus, registration processing of a payment means of the plurality of customers C is performed, and each piece of the personal identification information and each piece of the payment means determination information acquired from the QR codes 310 of the plurality of customers C are stored in the storage apparatus 120 (FIG. 10(a)) in association with each other.

Further, the customer C in which payment authentication has failed in step S325 (NO in step S325) is notified of that authentication has failed (step S327). Specifically, a message conveying to the customer C that authentication of the payment means has failed, re-registration by another payment means is recommended, and the like is output (displayed or audio output) to the order terminal 100. Further, information on authentication failure may be notified to the store apparatus 30 or an employee terminal 50. Information on authentication failure may include, for example, information such as identification information (e.g., including a table number) of the order terminal 100, a date and time, and information on the acquired QR code 310. Furthermore, since payment means determination information of the customer C is not registered in the storage apparatus 120, the customer C has to perform accounting by payment using another method such as cash in the end.

When accounting related to an order of a plurality of customers C is performed, the following plurality of patterns are conceivable as an accounting method.
(A) A bill is divided evenly by the number of the customers C (the number of registered payment means).
(B) One person (only a payment means of one person is registered) performs payment as a representative
(C) Each individual of the customers C performs payment only for what is ordered
(D) Some of the customers C perform payment by splitting a bill (individually specifying a ratio or an amount)

<<Accounting Patterns A and B>>

First, the accounting patterns A and B described above are described.

When registration processing of a payment means is finished in step S301 described above, and order reception processing in step S305 is performed, the reception unit 104 receives an operation on an order reception screen displayed on the display 130 of the order terminal 100, and stores acquired order information in the storage apparatus 120. Further, by receiving pressing of the order determination button on the order reception screen, the reception unit 104 determines an order, and transmits the stored order information to the store apparatus 30. This enables to start cooking, and provide an ordered dish to the customer C.

Then, when the customer C finishes eating and leaves the store, payment processing in step S311 is started. A timing when the payment processing is started may be any of (1) to (4) described above, and the customer C does not necessarily have to finish eating, or does not have to leave the store.

<S311: Payment Processing>

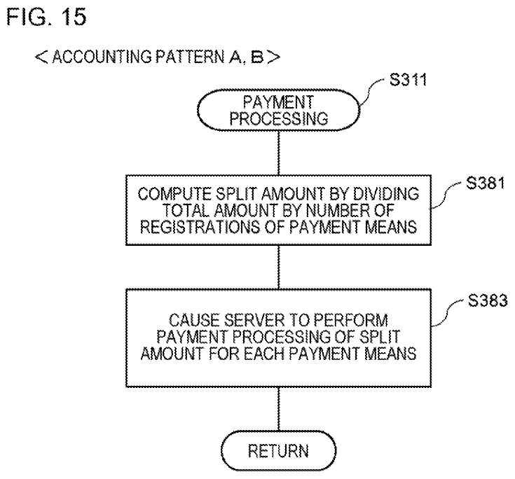

FIG. 15 is a flowchart illustrating a detailed operation example of the payment processing in step S311 in FIG. 13. The payment unit 106 acquires the number of payment means registered in the storage apparatus 120 in step S301, and computes a split amount by dividing a total amount of a price computed based on the order information received in step S305 by the number of registrations of the payment means (step S381).

Then, the payment server 200 corresponding to the payment means is caused to perform each piece of payment processing by using the payment means registered in step S301 by the split amount computed in step S381 (step S383). For example, in a case where only one payment means is registered, the pattern (B) is applied, and a price is paid by using the payment means of the representative. In a case where a plurality of payment means are registered, the pattern (A) is applied, and payment can be performed by evenly splitting a price by the each registered payment means.

<<Accounting Pattern C>>

Next, the pattern (C) in which each individual of the customers C performs payment for what is ordered is described. This example is based on a premise that each of the customers C has already registered a payment means in step S301. First, details on the order reception processing in step S305 are described.

<S305: Order Reception Processing>

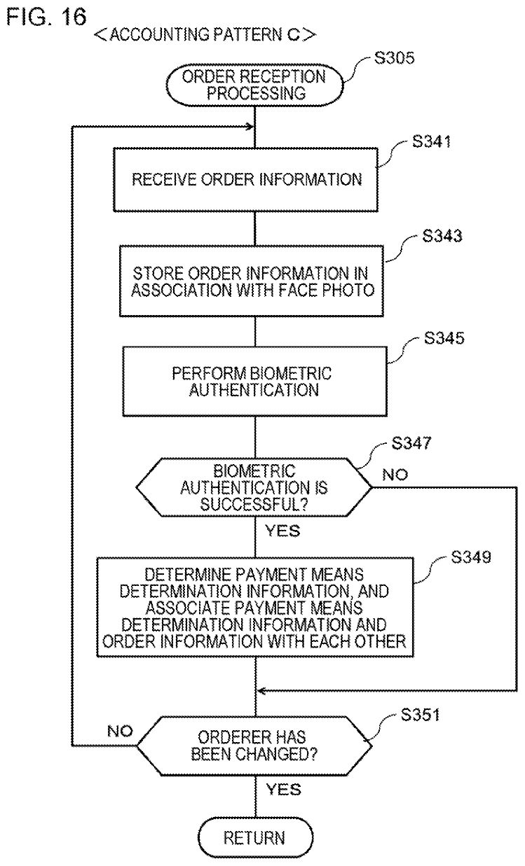

FIG. 16 is a flowchart illustrating a detailed operation example of the order reception processing in step S305 in FIG. 13.

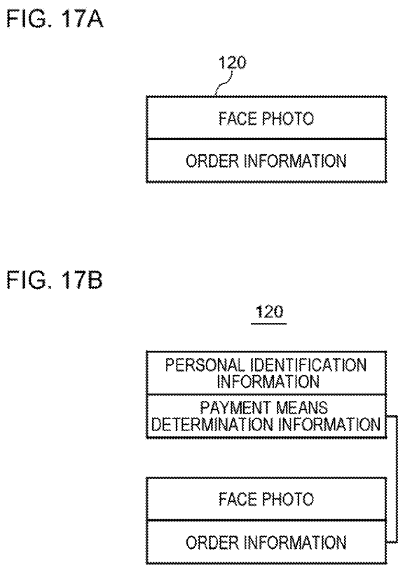

First, the reception unit 104 causes the display 130 of the order terminal 100 to display an order reception screen, and receives an order operation of the customer C (step S341). When order reception processing by the reception unit 104 is started, concurrently with step S341, the authentication unit 102 photographs a face of the customer C who is performing an order operation on the order terminal 100 with use of a camera of the order terminal 100, and stores, in the storage apparatus 120 (FIG. 17(a)), a captured image of the face of the customer C in association with order information received in step S341 (step S343).

Further, the authentication unit 102 performs biometric authentication processing of the customer C with use of the face image of the customer C (step S345). Specifically, the authentication unit 102 photographs a face of the customer C who is performing an order operation on the order terminal 100 with use of a camera of the order terminal 100, and acquires a feature value of the face of the customer C from a captured image. Then, the authentication unit 102 collates the acquired feature value of the face of the customer C with the personal identification information (feature value of a face) stored in the storage apparatus 120 (FIG. 10(a)).

As a result of the collation, in a case where personal identification information in which a degree of matching with the feature value of the face of the captured image of the customer C becomes equal to or more than a threshold value, and being stored in the storage apparatus 120 is found, it is determined that biometric authentication of the customer C is successful (YES in step S347). Then, the authentication unit 102 determines payment means determination information being associated with the personal identification information in which authentication is successful, and associates the payment means determination information with the order information recorded in step S343 (FIG. 17(b)) (step S349)

On the other hand, regarding the customer C in which biometric authentication in step S345 has failed (NO in step S347), the processing bypasses step S349.

Further, the authentication unit 102 detects whether the customer C being an orderer who is operating the order terminal 100 has been changed by photographing the customer C who is operating on the order terminal 100 with use of a camera and performing face authentication (step S351). The processing returns to step S341 until the orderer is changed (NO in step S351), and order reception processing is repeated. At this occasion, the biometric authentication processing in step S345 may be bypassed in a case where the orderer is not changed. In this case, information as to whether biometric authentication of the customer C is successful is held, and storing of order information of the customer C is continued by determining information (face photo) to be recorded in association with received order information.

When the authentication unit 102 detects that an orderer who is operating on the order terminal 100 has been changed (YES in step S351), the present processing is finished, and the processing returns to FIG. 13.

Until pressing of the order determination button is received in step S307 in FIG. 13, steps S341 to S351 in FIG. 16 are repeated regarding the other customers C by the number of orderers. This enables to perform order reception processing of the plurality of customers C, store a face photo of each customer C in the storage apparatus 120 (FIG. 17(a)) in association with order information of the plurality of customers C, and also transmit the information to the store apparatus 30, as order information (step S309). In the store apparatus 30, upon receiving the order information, the order information is conveyed to a kitchen, and cooking is started.

Transmitting order information and a face photo to the store apparatus 30 in association with each other enables to transmit the order information and the face photo from the store apparatus 30 to the employee terminal 50 in association with each other, when an employee S serves an ordered dish to each customer C, and causing the employee terminal 50 to display the face photo and the order information in association with each other allows the employee S to serve without mistaking combination of an ordered dish and the customer C.

<S311: Payment Processing>

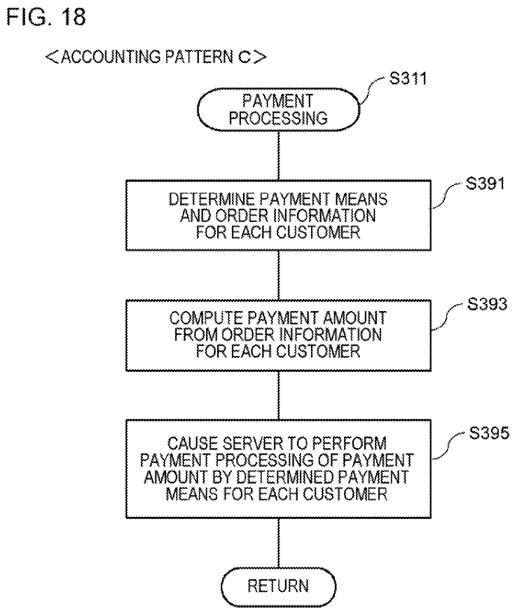

FIG. 18 is a flowchart illustrating another detailed operation example of the payment processing in step S311 in FIG. 13. This example is the accounting pattern (C) described above, and is a pattern in which a price is paid for what is ordered by each customer C. A timing when the present processing is performed can be any of the accounting timings (1) to (4) described above.

First, the payment unit 106 determines payment means determination information being associated with order information in the storage apparatus 120 (FIG. 17(b)) for each customer C, and determines a payment means for use in payment of a price by the customer C (step S391). Next, the payment unit 106 computes a payment amount of the customer C from order information of the customer C (step S393). Note that, computation processing of a payment amount may be performed by the store apparatus 30. The order terminal 100 may acquire a payment amount computed by the store apparatus 30.

Then, the payment unit 106 causes the payment server 200 corresponding to the payment means of the customer C to perform payment processing of the payment amount computed in step S393 by using the payment means of the customer C determined in step S391 (step S395). Specifically, identification information of the payment means of the customer C, and the payment amount are transmitted to the payment server 200 together with a payment request.

In this configuration, a price for a product ordered individually by each customer C can be paid by a payment means of the customer C.

<<Accounting Pattern D>>

Lastly, the accounting pattern (D) described above in which payment is performed by splitting a bill (individually specifying a ratio or an amount) among some of the customers C is described.

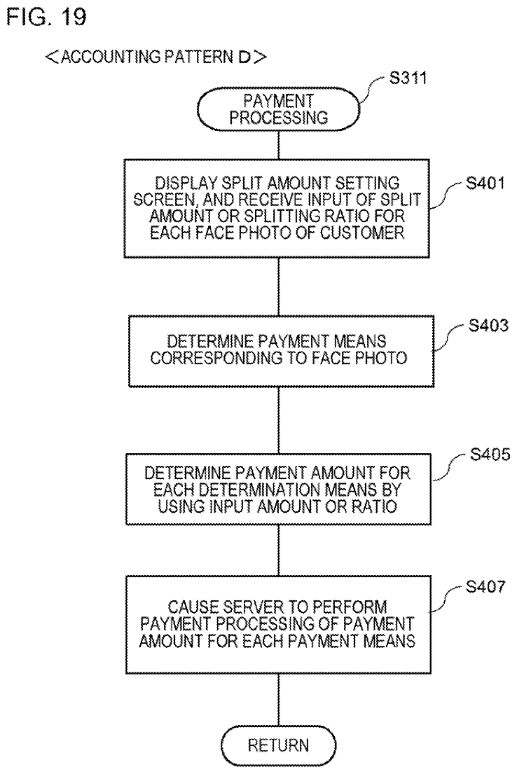

FIG. 19 is a flowchart illustrating still another detailed operation example of the payment processing in step S311 in FIG. 13.

In this example, since the payment means registration processing in step S301 and the order reception processing in step S305 are the same as those in the accounting pattern (A) described above, description thereof is not included.

First, when payment processing is started, the payment unit 106 causes the display 130 of the order terminal 100 to display a split amount setting screen. For example, the payment unit 106 displays, on the split amount setting screen, a face photo of the customer C whose payment means determination information stored in the storage apparatus 120 in FIG. 17(b) is registered, and receives an input of a split amount or a splitting ratio for each customer C (step S401). Note that, on the split amount setting screen, a payment amount computed from order information being associated with a face photo may be displayed together with the face photo.

The payment unit 106 further acquires payment means determination information being associated with order information corresponding to the face photo, and determines a payment means indicated by the payment means determination means (step S403).

The payment unit 106 computes a payment amount for each payment means by using the split amount or the splitting ratio received in step S401 (step S405). The payment unit 106 may display a computed payment amount on a payment confirmation screen for each face photo. Further, information (e.g., xxPay) or the like on the payment means determined in step S403 may also be displayed. Then, a payment amount of each payment means is determined by receiving pressing of a determination button on the payment confirmation screen.

Note that, in a case of specifying a payment amount, in a case where a total amount is different from a billing amount, the payment unit 106 may notify the customer C to change the payment amount, or automatically adjust the payment amount and notify the customer C of a payment amount after the adjustment.

Then, the payment unit 106 causes the payment server 200 corresponding to the payment means to perform payment processing of the payment amount for each payment means (step S407).

According to the present example embodiment, even in a case where a plurality of customers C perform accounting by splitting a bill, an advantageous effect similar to that of the above-described example embodiments can be provided, and payment processing can be efficiently performed. Further, since an orderer and order details can be associated with each other, the orderer himself/herself can individually perform payment for what is ordered.

In the foregoing, example embodiments according to the present invention have been described with reference to the drawings, however, these example embodiments are an example of the present invention, and various configurations other than the above can also be adopted.

<Age Estimation>

For example, in biometric authentication processing at a time of order reception processing, the authentication unit 102 may estimate an age of the customer C from a face image of the customer C photographed by a camera of the order terminal 100. Further, the authentication unit 102 determines whether the estimated age is an age (e.g., an adult) at which alcohol drinking is legal, or not (e.g., an underage). In a case where it is determined that the estimated age is not an age at which alcohol drinking is legal, the reception unit 104 may inactivate or erase an order button on an order reception screen in such a way that an order of alcohol drinks or the like cannot be placed.

Further, age information of the customer C may be recorded in the QR code 310 together with personal identification information. In eKYC processing, since information on an identification card can be acquired, for example, an age may be computed from birthday information on a card surface, and the age may be recorded in the QR code 310.

<Usage Notification>

Further, in another example embodiment, when the order terminal 100 generates the QR code 310 for payment means registration processing at a time of entering a store, a notification unit (not illustrated) that transmits a notification to a predetermined destination may be further included. At a time of user registration in advance in the present ordering system 1, the customer C registers a predetermined destination, for example, a mail address, a mobile phone number, and the like, as a notification contact.

According to the configuration, it is possible to prevent unauthorized use of a payment means of the customer C by impersonation.

Further, an approval operation for use of the payment means may be received when the customer C who has received the notification accesses to a uniform resource locator (URL) written in the notification, and presses an approval button. The payment unit 106 may be configured to allow use of the payment means, only in a case where an approval operation is received. The authentication unit 102 and the payment unit 106 may validate use of the payment means, only in a case where an approval operation of the customer C is received.

Further, in the foregoing, in a case where pressing of a non-approval button is received, the authentication unit 102 and the payment unit 106 stop use of the payment means. Further, the authentication unit 102 or the payment unit 106 may notify the store apparatus 30 and the employee terminal 50 of that use of the payment means has not been approved, and that there is a risk of unauthorized use.

While the invention of the present application has been described with reference to the example embodiments and examples, the invention of the present application is not limited to the above-described example embodiments and examples. A configuration and details of the invention of the present application may be modified in various ways comprehensible to a person skilled in the art within the scope of the invention of the present application.

Note that, in a case where information related to a user is acquired and used in the present invention, the acquisition and the use are assumed to be performed legally.

A part or all of the above-described example embodiments may also be described as the following supplementary notes, but is not limited to the following.

1. A terminal apparatus including:
an authentication unit that performs authentication related to a payment means by transmitting, before receiving order information from a customer, payment means determination information of the customer to a server that authenticates the payment means and causing the server to perform predetermined payment processing;
a reception unit that receives order information of the customer after the authentication is successful; and
a payment control unit that causes the server to perform payment processing related to the order information by using the acquired payment means determination information.

2. The terminal apparatus according to supplementary note 1, wherein
the payment control unit acquires again payment means determination information from a user terminal of the customer, when payment processing related to the order information is performed.

3. The terminal apparatus according to supplementary note 1 or 2, wherein
the authentication unit
   transmits that a payment amount is 0 yen together with payment request information of requesting payment to the server in the predetermined payment processing, and
   a condition that the authentication is successful is that the payment is completed.

4. The terminal apparatus according to any one of supplementary notes 1 to 3, wherein
the authentication unit acquires personal identification information of the customer together with the payment means determination information, and stores, in a storage unit, the personal identification information and the payment means determination information in association with each other,
when receiving the order information of the customer, the reception unit acquires biometric information of the customer, collates the acquired biometric information with the personal identification information stored in the storage unit, and stores, in the storage unit, the received order information in association with the personal identification information that matches the biometric information, and,
when performing the payment processing related to the order information, the payment control unit causes the server to perform the payment processing related to the order information being associated with the personal identification information of the customer by using the payment means determination information being associated with the acquired personal identification information of the customer.

5. The terminal apparatus according to supplementary note 4, wherein
the personal identification information is biometric information.

6. A payment method including,
by a terminal apparatus:
performing authentication related to a payment means by transmitting, before receiving order information from a customer, payment means determination information of the customer to a server that authenticates the payment means and causing the server to perform predetermined payment processing;
receiving order information of the customer after the authentication is successful; and
causing the server to perform payment processing related to the order information by using the acquired payment means determination information.

7. The payment method according to supplementary note 6, further including,
by the terminal apparatus,
acquiring again payment means determination information from a user terminal of the customer, when payment processing related to the order information is performed.

8. The payment method according to supplementary note 6 or 7, further including,
by the terminal apparatus,
transmitting that a payment amount is 0 yen together with payment request information of requesting payment to the server in the predetermined payment processing, wherein
a condition that the authentication is successful is that the payment is completed.

9. The payment method according to any one of supplementary notes 6 to 8, further including, by the terminal apparatus:
acquiring personal identification information of the customer together with the payment means determination information, and storing, in a storage unit, the personal identification information and the payment means determination information in association with each other;
when receiving the order information of the customer, acquiring biometric information of the customer, collating the acquired biometric information with the personal identification information stored in the storage unit, and storing, in the storage unit, the received order information in association with the personal identification information that matches the biometric information; and,
when performing the payment processing related to the order information, causing the server to perform the payment processing related to the order information being associated with the personal identification information of the customer by using the payment means determination information being associated with the acquired personal identification information of the customer.

10. The payment method according to supplementary note 9, wherein the personal identification information is biometric information.

11. A program causing a computer to execute:
a procedure of performing authentication related to a payment means by transmitting, before receiving order information from a customer, payment means determination information of the customer to a server that authenticates the payment means and causing the server to perform predetermined payment processing;
a procedure of receiving order information of the customer after the authentication is successful; and
a procedure of causing the server to perform payment processing related to the order information by using the acquired payment means determination information.

12. The program according to supplementary note 11 causing a computer to further execute
a procedure of acquiring again payment means determination information from a user terminal of the customer, when payment processing related to the order information is performed.

13. The program according to supplementary note 11 or 12 causing a computer to further execute,
a procedure of transmitting that a payment amount is 0 yen together with payment request information of requesting payment to the server in the predetermined payment processing, wherein
a condition that the authentication is successful is that the payment is completed.

14. The program according to any one of supplementary notes 11 to 13 causing a computer to further execute:
a procedure of acquiring personal identification information of the customer together with the payment means determination information, and storing, in a storage unit, the personal identification information and the payment means determination information in association with each other;
when receiving the order information of the customer, a procedure of acquiring biometric information of the customer, collating the acquired biometric information with the personal identification information stored in the storage unit, and storing, in the storage unit, the received order information in association with the personal identification information that matches the biometric information; and,
when performing the payment processing related to the order information, a procedure of causing the server to perform the payment processing related to the order information being associated with the personal identification information of the customer by using the payment means determination information being associated with the acquired personal identification information of the customer.

15. The program according to supplementary note 14, wherein
the personal identification information is biometric information.

This application is based upon and claims the benefit of priority from Japanese patent application No. 2020-175965, filed on Oct. 20, 2020, the disclosure of which is incorporated herein in its entirety by reference.

### Example Embodiment

1 Ordering system
2 Communication network
10 User terminal
12 Display
30 Store apparatus
32 Storage apparatus
50 Employee terminal
70 Identification card
100 Order terminal
102 Authentication unit
104 Reception unit
106 Payment unit
120 Storage apparatus
130 Display
200 Payment server
300 Guidance screen
310 QR code
400 Screen
410 QR code
1000 Computer
1010 Bus
1020 Processor
1030 Memory
1040 Storage device
1050 Input/output interface
1060 Network interface

What is claimed is:

1. A terminal apparatus comprising:
at least one memory configured to store instructions; and
at least one processor configured to execute the instructions to:
perform authentication related to payment means by transmitting, before receiving order information from a customer, payment means determination information of the customer to a server that authenticates the payment means and causing the server to perform predetermined payment processing;
receive order information of the customer after the authentication is successful; and
cause the server to perform payment processing related to the order information by using the acquired payment means determination information.

2. The terminal apparatus according to claim 1, wherein
the at least one processor is configured to execute the instructions to
acquire again payment means determination information from a user terminal of the customer, when payment processing related to the order information is performed.

3. The terminal apparatus according to claim 1, wherein
the at least one processor is configured to execute the instructions to
transmit that a payment amount is 0 yen together with payment request information of requesting payment to the server in the predetermined payment processing, and
a condition that the authentication is successful is that the payment is completed.

4. The terminal apparatus according to claim 1, wherein
the at least one processor is configured to execute the instructions to:
acquire personal identification information of the customer together with the payment means determination information, and stores, in storage unit, the personal identification information and the payment means determination information in association with each other,
when receiving the order information of the customer, acquire biometric information of the customer, collate the acquired biometric information with the personal identification information stored in the storage unit, and store, in the storage unit, the received order information in association with the personal identification information that matches the biometric information, and,
when performing the payment processing related to the order information, cause the server to perform the payment processing related to the order information being associated with the personal identification information of the customer by using the payment unit determination information being associated with the acquired personal identification information of the customer.

5. The terminal apparatus according to claim 4, wherein
the personal identification information is biometric information.

6. A payment method comprising,
by a terminal apparatus:
performing authentication related to payment means by transmitting, before receiving order information from a customer, payment means determination information of the customer to a server that authenticates the payment means and causing the server to perform predetermined payment processing;
receiving order information of the customer after the authentication is successful; and
causing the server to perform payment processing related to the order information by using the acquired payment means determination information.

7. The payment method according to claim 6, further comprising,
by the terminal apparatus,
acquiring again payment means determination information from a user terminal of the customer, when payment processing related to the order information is performed.

8. The payment method according to claim 6, further comprising,
by the terminal apparatus,
transmitting that a payment amount is 0 yen together with payment request information of requesting payment to the server in the predetermined payment processing, wherein
a condition that the authentication is successful is that the payment is completed.

9. The payment method according to claim 6, further comprising,
by the terminal apparatus:
acquiring personal identification information of the customer together with the payment means determination information, and storing, in storage unit, the personal identification information and the payment means determination information in association with each other;
when receiving the order information of the customer, acquiring biometric information of the customer, collating the acquired biometric information with the personal identification information stored in the storage unit, and storing, in the storage unit, the received order information in association with the personal identification information that matches the biometric information; and,
when performing the payment processing related to the order information, causing the server to perform the payment processing related to the order information being associated with the personal identification information of the customer by using the payment means determination information being associated with the acquired personal identification information of the customer.

10. The payment method according to claim 9, wherein
the personal identification information is biometric information.

11. A non-transitory computer-readable storage medium storing a program causing a computer to execute:
a procedure of performing authentication related to payment means by transmitting, before receiving order information from a customer, payment means determination information of the customer to a server that authenticates the payment means and causing the server to perform predetermined payment processing;
a procedure of receiving order information of the customer after the authentication is successful; and
a procedure of causing the server to perform payment processing related to the order information by using the acquired payment means determination information.

12. The non-transitory computer-readable storage medium according to claim 11, wherein the program causes a computer to further execute
a procedure of acquiring again payment means determination information from a user terminal of the customer, when payment processing related to the order information is performed.

13. The non-transitory computer-readable storage medium according to claim 11, wherein the program causes a computer to further execute,
in the procedure of performing the authentication,
a procedure of transmitting that a payment amount is 0 yen together with payment request information of requesting payment to the server in the predetermined payment processing, wherein
a condition that the authentication is successful is that the payment is completed.

14. The non-transitory computer-readable storage medium according to claim 11, wherein the program causes a computer to further execute:
a procedure of acquiring personal identification information of the customer together with the payment means determination information, and storing, in storage unit, the personal identification information and the payment means determination information in association with each other;
when receiving the order information of the customer, a procedure of acquiring biometric information of the customer, collating the acquired biometric information with the personal identification information stored in the storage unit, and storing, in the storage unit, the received order information in association with the personal identification information that matches the biometric information; and,
when performing the payment processing related to the order information, a procedure of causing the server to perform the payment processing related to the order information being associated with the personal identification information of the customer by using the payment means determination information being associated with the acquired personal identification information of the customer.

15. The non-transitory computer-readable storage medium according to claim 14, wherein
the personal identification information is biometric information.
